(19) United States
(12) Patent Application Publication
(10) Pub. No.: US 2025/0220319 A1
(43) Pub. Date: Jul. 3, 2025

(54) IMAGE SENSING DEVICE AND IMAGING DEVICE INCLUDING THE SAME

(71) Applicant: SK hynix Inc., Gyeonggi-do (KR)

(72) Inventor: Wan Seon SHIN, Gyeonggi-do (KR)

(21) Appl. No.: 19/000,706

(22) Filed: Dec. 24, 2024

(30) Foreign Application Priority Data
Jan. 3, 2024 (KR) 10-2024-0000926

(51) Int. Cl. H04N 25/616; H04N 25/75

(52) U.S. Cl. CPC H04N 25/616; H04N 25/75

(57) ABSTRACT

An image sensing device may include a test control switch configured to selectively connect a test reset line for transmitting a test reset signal and a test image line for transmitting a first test image signal and a first correlated double sampling (CDS) circuit configured to receive the test reset signal through the test reset line and receive the first test image signal through the test image line. The first CDS circuit may receive a second test image signal through the test image line when the test control switch is closed.

### CROSS-REFERENCES TO RELATED APPLICATION

This patent application claims priority to Korean application number 10-2024-0000926, filed on Jan. 3, 2024, which is incorporated herein by reference in its entirety.

### BACKGROUND

### 1. Technical Field

Various embodiments of the present disclosure relate to an image sensing device and an imaging device including the same.

### 2. Related Art

An image sensing device is a device for capturing an optical image by using the property of a light sensing semiconductor material that reacts to light. With the development of vehicle, medical treatment, computer, and communication industries, there is an increasing demand for high-performance image sensing devices in various fields, such as smartphones, digital cameras, gaming devices, Internet of Things, robots, cameras for security, and microcameras for medical treatment.

Recently, in order to provide a high quality image, various schemes for detecting a defect in an image sensing device are being developed. Among the various schemes, research and development for interpolating a pixel having omitted information by using information of neighboring pixels or detecting a pixel having a defect in the image sensing device are performed.

### SUMMARY

In an embodiment of the present disclosure, an image sensing device may include a test control switch configured to selectively connect a test reset line for transmitting a test reset signal and a test image line for transmitting a first test image signal, and a first correlated double sampling (CDS) circuit configured to receive the test reset signal through the test reset line and receive the first test image signal through the test image line. The first CDS circuit may receive a second test image signal through the test image line when the test control switch is closed.

In an embodiment of the present disclosure, an image sensing device may include a test control switch configured to selectively connect a test reset line for transmitting a test reset signal generated from a test circuit and a test image line for transmitting a test image signal generated from the test circuit, and a correlated double sampling (CDS) circuit configured to receive the test image signal through the test image line and receive the test reset signal through the test reset line. The test control switch may control a difference between the test image signal and the test reset signal that are input to the CDS circuit.

In an embodiment of the present disclosure, a method of controlling an image sensing device may include transmitting a test image signal and a test reset signal through a first test image line and a first test reset line, respectively, to a first correlated double sampling (CDS) circuit included in the image sensing device, transmitting a test image signal and a test reset signal through a second test image line and a second test reset line, respectively, to a second CDS circuit included in the image sensing device, and controlling a difference between the test image signal and the test reset signal that are input to the first CDS circuit by selectively connecting the first test image line and the first test reset line.

### BRIEF DESCRIPTION OF THE DRAWINGS

FIG. 1 is a block diagram illustrating a configuration of an imaging device according to an embodiment of the present disclosure.

FIG. 2 is a circuit diagram illustrating a detailed configuration of a pixel included in a pixel array of FIG. 1, according to an embodiment of the present disclosure.

FIG. 3 is a block diagram illustrating a detailed configuration of an ADC of FIG. 1, according to an embodiment of the present disclosure.

FIG. 4 is a block diagram illustrating a configuration of a test circuit connected to the ADC of FIG. 1, according to an embodiment of the present disclosure.

FIG. 5A is a graph illustrating a difference between power of a test image signal and a test reset signal according to an embodiment of the present disclosure.

FIG. 5B is an image that is output in accordance with a difference between power of the test image signal and the test reset signal in FIG. 5A, according to an embodiment of the present disclosure.

FIG. 6A is a graph illustrating a difference between power of a test image signal and a test reset signal according to an embodiment of the present disclosure.

FIG. 6B is an image that is output in accordance with a difference between power of the test image signal and the test reset signal in FIG. 6A, according to an embodiment of the present disclosure.

FIG. 7 is a diagram for describing an operation of the test circuit of FIG. 4 corresponding to the image of FIG. 6B, according to an embodiment of the present disclosure.

FIG. 8 is a timing diagram of the test circuit, according to an embodiment of the present disclosure.

### DETAILED DESCRIPTION

Hereafter, various embodiments of the present disclosure will be described with reference to the accompanying drawings. However, it should be noted that the present disclosure is not limited to specific embodiments, but includes various modifications, equivalents and/or alternatives of an embodiment. An embodiment of the present disclosure may provide various effects which can be recognized directly and indirectly through the present disclosure.

Various embodiments of the present disclosure are directed to providing an image sensing device for detecting a defect in an image data output operation and an imaging device including the same.

The technical problems of the present disclosure are not limited to the above-mentioned technical problems, and other technical problems which are not mentioned herein will be clearly understood by those skilled in the art from the following descriptions.

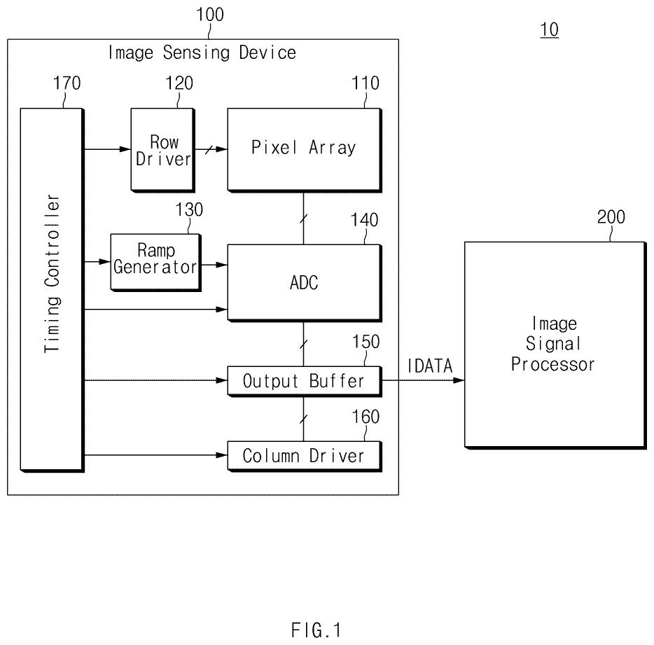

FIG. 1 is a block diagram illustrating a configuration of an imaging device 10 according to an embodiment of the present disclosure.

Referring to FIG. 1, the imaging device 10 may be a device, such as a digital still camera for capturing a still image or a digital video camera for capturing a moving image. For example, the imaging device 10 may be implemented as a digital single lens reflex (DSLR) camera, a mirrorless camera, or a smartphone, but the embodiments are not limited thereto. The imaging device 10 may be a device capable of photographing a subject and generating an image, including an image pickup device.

The imaging device 10 may include an image sensing device 100 and an image signal processor (ISP) 200.

The image sensing device 100 may be a complementary metal oxide semiconductor image sensor (CIS) for converting incident light into an electrical signal. The image sensing device 100 may include a pixel array 110, a row driver 120, a ramp generator 130, an analog-digital converter (ADC) 140, an output buffer 150, a column driver 160, and a timing controller 170. In this case, each of the components of the image sensing device 100 may be merely an example, and at least some components may be added to the image sensing device 100 or at least some components of the image sensing device 100 may be omitted, if necessary.

The pixel array 110 may include a plurality of pixels that are arranged in a plurality of rows and a plurality of columns. In an embodiment, the plurality of pixels may be arranged in the form of a two-dimensional (2-D) pixel array including rows and columns. In another embodiment, a plurality of unit image pixels may be arranged in the form of a 3-D pixel array. The plurality of pixels may convert a light signal into an electrical signal in a pixel unit or a pixel group unit. Pixels within a pixel group may share at least one internal circuit. The pixel array 110 may receive driving signals, including a row selection signal, a pixel reset signal, and a transmission signal, from the row driver 120. A corresponding pixel of the pixel array 110 may be activated to perform an operation corresponding to a row selection signal, a pixel reset signal, and a transmission signal by a driving signal.

Each pixel of the pixel array 110 may have two or more different sensitivities. In this case, the sensitivity may mean an increment (or an increment of a response) of image data IDATA for an increment of the intensity of incident light. That is, as the sensitivity is increased, an increment of the image data IDATA for an increment of the intensity of the incident light may be increased. As the sensitivity is decreased, an increment of the image data IDATA for an increment of the intensity of the incident light may be reduced. In the present disclosure, the sensitivity may be determined by a conversion gain.

The row driver 120 may activate the pixel array 110 so that the pixel array 110 performs specific operations on pixels included in a corresponding row, based on instructions and/or control signals that are supplied by the timing controller 170. In an embodiment, the row driver 120 may select at least one pixel that is arranged in at least one row of the pixel array 110. The row driver 120 may generate a row selection signal in order to select at least one row among a plurality of rows. The row driver 120 may sequentially enable a pixel reset signal and a transmission signal with respect to pixels corresponding to the selected at least one row. Accordingly, a reference signal and an image signal having an analog form, which are generated from each of the pixels of the selected row, may be sequentially transmitted to the ADC 140. In this case, the reference signal may be an electrical signal that is provided to the ADC 140 when a sensing node (e.g., a floating diffusion region) of a pixel is reset. The image signal may be an electrical signal that is provided to the ADC 140 when optical charges generated by the pixel are accumulated in the sensing node. The reference signal indicative of reset noise unique to a pixel and the image signal indicative of the intensity of incident light may be commonly called a pixel signal.

A CMOS image sensor may use correlated double sampling (CDS) so that an unwanted offset value of a pixel, such as fixed pattern noise, can be removed by sampling a pixel signal twice in order to remove a difference between two samples. For example, through the CDS, a pixel output voltage based on only incident light may be measured by removing an unwanted offset value through a comparison between pixel output voltages that are obtained before and after optical charges generated by the incident light are accumulated in a sensing node. In an embodiment, the ADC 140 may sequentially sample and hold a reference signal and an image signal that are provided by each of a plurality of column lines from the pixel array 110.

The ramp generator 130 may generate a ramp signal that is necessary for an ADC operation of the ADC 140 and supply the ramp signal to the ADC 140, under the control of the timing controller 170.

The ADC 140 may sample and hold a pixel signal for each column, which is output from each column line of the pixel array 110, and may output the pixel signal by converting the pixel signal into a digital signal. In an embodiment, the ADC 140 may be implemented as a ramp-compare type ADC. The ramp-compare type ADC may include a comparison circuit for comparing a ramp signal that rises or falls over time and a pixel signal having an analog form and a counter for performing a counting operation until a ramp signal is matched with an analog pixel signal.

The output buffer 150 may temporarily hold and output image data (i.e., data IDATA digitally converted from a pixel signal) having a column unit, which is supplied by the ADC 140. The output buffer 150 may temporarily store the image data IDATA that are output by the ADC 140 based on control of the timing controller 170. The output buffer 150 may operate as an interface for compensating for a difference between the transmission (or processing) speeds of devices connected to the image sensing device 100.

The column driver 160 may select a column of the output buffer 150 based on control of the timing controller 170, and may control the output buffer 150 so that the image data IDATA temporally stored in the selected column of the output buffer 150 are sequentially output. In an embodiment, the column driver 160 may receive an address signal from the timing controller 170. The column driver 160 may select a column of the output buffer 150 by generating a column selection signal based on the address signal so that the image data IDATA are controlled to be output from the selected column of the output buffer 150 to the outside.

The timing controller 170 may control at least one of the row driver 120, the ramp generator 130, the ADC 140, the output buffer 150, and the column driver 160.

The timing controller 170 may provide at least one of the row driver 120, the ramp generator 130, the ADC 140, the output buffer 150, and the column driver 160 with a clock signal that is necessary for an operation of each of the components of the image sensing device 100, a control signal for timing control, and address signals for selecting a row or a column. According to an embodiment, the timing controller 170 may include a logic control circuit, a phase lock loop (PLL) circuit, a timing control circuit, and a communication interface circuit.

The ISP 200 may perform image signal processing on the image data IDATA that are received from the image sensing device 100. The ISP 200 may reduce noise of the image data IDATA, and may perform image signal processing for picture quality improvements, such as the interpolation, synthesis, and gamma corrections of the image data IDATA, color filter array interpolation, a color matrix, color corrections, color enhancement, and lens distortion corrections. Furthermore, the ISP 200 may generate an image file by compressing and processing image data that have been generated by performing the image signal processing for picture quality improvements, or may restore image data from the image file. A compression format for an image may be a reversible form or an irreversible form. As an example of the compression format, in the case of a still image, a joint photographic experts group (JPEG) format or a JPEG 2000 format may be used. Furthermore, in the case of a moving image, a moving image file may be generated by compressing a plurality of frames according to the moving picture experts group (MPEG) standard. The image file may be generated according to the exchangeable image file format (Exif) standard, for example.

The ISP 200 may transmit, to a host device (not illustrated), image data on which an image processing operation has been completed. The host device (not illustrated) may be a processor (e.g., an application processor) for processing image data on which image processing has been performed, which are received from the ISP 200, memory (e.g., nonvolatile memory) for storing the image data, or a display device (e.g., a liquid crystal display (LCD)) for visually outputting the image data.

Furthermore, the ISP 200 may transmit, to the image sensing device 100, a control signal for controlling an operation (e.g., whether to operate the image sensing device 100, operation timing of the image sensing device 100, or an operation mode of the image sensing device 100) of the image sensing device 100.

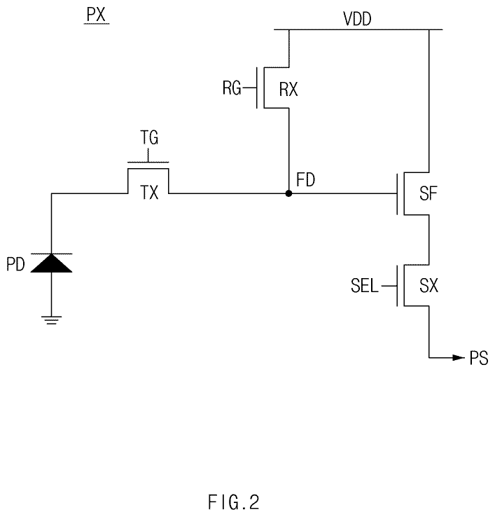

FIG. 2 is a circuit diagram illustrating a detailed configuration of a pixel PX included in the pixel array 110 of FIG. 1, according to an embodiment of the present disclosure.

Referring to FIG. 2, the pixel PX may be one of a plurality of pixels included in the pixel array 110. One pixel PX is illustrated in FIG. 2, but other pixels of the plurality of pixels may have substantially the same configuration and operation as the pixel PX.

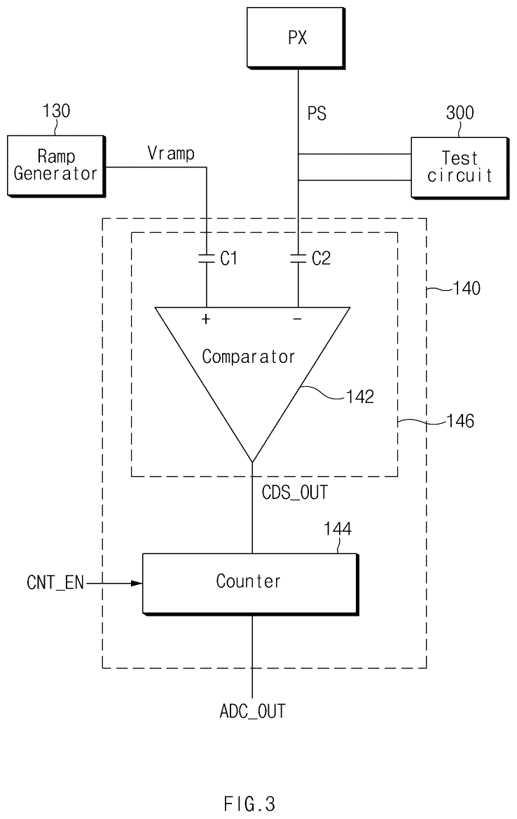

The pixel PX may include a photoelectric conversion element PD, a transmission transistor TX, a reset transistor RX, a floating diffusion region FD, a source follower transistor SF, and a selection transistor SX. FIG. 3 illustrates that the pixel PX includes one photoelectric conversion element PD. However, the pixel PX may be a shared pixel having a plurality of photoelectric conversion elements according to another embodiment of the present disclosure. In this case, a plurality of transmission transistors may be provided in accordance with the plurality of photoelectric conversion elements.

The photoelectric conversion element PD may generate and accumulate optical charges corresponding to the intensity of incident light. For example, the photoelectric conversion element PD may be implemented as a photodiode, a phototransistor, a photogate, a pinned photodiode, or a combination of them.

If the photoelectric conversion element PD is implemented as a photodiode, the photoelectric conversion element PD may be a region in which a substrate having a first conductive type (e.g., a P type) has been doped with impurities having a second conductive type (e.g., an N type).

The transmission transistor TX may be connected between the photoelectric conversion element PD and the floating diffusion region FD. The transmission transistor TX may be turned on or off in response to a transmission signal TG. The transmission transistor TX that has been turned on may transmit, to the floating diffusion region FD, optical charges that have been accumulated in the photoelectric conversion element PD.

The reset transistor RX may be connected between a power supply voltage VDD and the floating diffusion region FD, and may reset a voltage of the floating diffusion region FD to the power supply voltage VDD in response to a pixel reset signal RG.

The floating diffusion region FD may receive the optical charges from the transmission transistor TX. The floating diffusion region FD may be connected to a gate of the source follower transistor SF, and may correspond to a region in which signal electrons are input and appear as a voltage. In an example, the floating diffusion region FD may be called a sensing node.

In the present disclosure, a logic high level may mean a voltage level for activating (e.g., turning on) a corresponding element (e.g., a transistor). A logic low level may mean a voltage level for deactivating (e.g., turning off) a corresponding element (e.g., a transistor).

The source follower transistor SF may be connected between the power supply voltage VDD and the selection transistor SX, and may transmit a corresponding electrical signal to the selection transistor SX by amplifying a change in the electrical potential of the floating diffusion region FD that has received the optical charges accumulated in the photoelectric conversion element PD.

The selection transistor SX may be connected between the source follower transistor SF and an output signal line, may be turned on by a selection control signal SEL, and may output an electrical signal that is received from the source follower transistor SF as a pixel signal PS.

FIG. 3 is a block diagram illustrating a detailed configuration of the ADC 140 of FIG. 1, according to an embodiment of the present disclosure.

Referring to FIG. 3, the ADC 140 may receive a ramp signal Vramp from the ramp generator 130, may receive the pixel signal PS from the pixel PX, may generate ADC data ADC_OUT based on the ramp signal Vramp and the pixel signal PS, and may output the ADC data ADC_OUT. In an example, the ADC 140 may receive the ramp signal Vramp from the ramp generator 130, may receive a test reset signal and a test image signal from the test circuit, may generate the ADC data ADC_OUT based on the ramp signal Vramp, the test reset signal, and the test image signal, and may output the ADC data ADC_OUT.

The ADC 140 may include first and second capacitors C1 and C2, a comparator 142, and a counter 144.

The first capacitor C1 may receive the ramp signal Vramp and transmit the ramp signal Vramp to the comparator 142. The second capacitor C2 may receive the pixel signal PS and transmit the pixel signal PS to the comparator 142.

The comparator 142 may compare the ramp signal Vramp and the pixel signal PS, may generate comparison data CDS_OUT based on a result of the comparison, and may transmit the comparison data CDS_OUT to the counter 144. According to an embodiment, when the ramp signal Vramp is greater than the pixel signal PS, the comparator 142 may generate the comparison data CDS_OUT having a logic high level. Furthermore, when the ramp signal Vramp is smaller than the pixel signal PS, the comparator 142 may generate the comparison data CDS_OUT having a logic low level. That is, the comparison data CDS_OUT may indicate a large and small relationship between the ramp signal Vramp and the pixel signal PS.

The counter 144 may be activated in response to a counter enable signal CNT_EN. The activated counter 144 may perform counting in response to the comparison data CDS_OUT having a logic high level, and may output the results of the counting as the ADC data ADC_OUT. The ADC data ADC_OUT may correspond to the image data IDATA described with reference to FIG. 1.

A CDS circuit 146 may correspond to a component including the first capacitor C1, the second capacitor C2, and the comparator 142, among the components of the ADC 140. In an example, the CDS circuit 146 may correspond to at least some region of the pixel array 110. In this case, the CDS circuit 146 may generate the CDS data CDS_OUT corresponding to the at least some region of the pixel array 110 to which the CDS circuit 146 corresponds. For example, the CDS circuit 146 may correspond to a first column of the pixel array 110. The CDS data CDS_OUT that are generated by the CDS circuit 146 may correspond to the first column of the pixel array 110.

According to an embodiment, the CDS circuit 146 may perform a CDS operation. A CMOS image sensor may use CDS so that an unwanted offset value of a pixel, such as fixed pattern noise, can be removed by twice sampling a pixel signal in order to remove a difference between two samples. The CDS circuit 146 may remove an unwanted offset value by comparing pixel output voltages that are obtained before and after optical charges generated by incident light are accumulated in the sensing node through a CDS operation, so that a pixel output voltage based on only the incident light may be measured.

A test circuit 300 may generate a test image signal and a test reset signal that are transmitted to the CDS circuit 146. The test image signal may correspond to an image signal that is used in a CDS operation. The test reset signal may correspond to a reference signal that is used in a CDS operation. In an example, in a wafer test step, the test circuit 300 may generate a test signal for detecting a defect in the image sensing device 100. For example, in a wafer test step for the image sensing device 100, the test circuit 300 may generate a test reset signal and a test image signal and transmit the test reset signal and the test image signal to the CDS circuit 146. The CDS circuit 146 may generate the CDS data CDS_OUT based on a result of a comparison between a difference between the test reset signal and the test image signal and the ramp signal Vramp.

According to an embodiment, the test circuit 300 may control timing at which a test reset signal and a test image signal are transmitted to the CDS circuit 146. In an example, the test circuit 300 may include a test reset control switch and a test image control switch. The test circuit 300 may transmit the test reset signal to the CDS circuit by closing the test reset control switch and opening the test image control switch, and may transmit the test image signal to the CDS circuit by opening the test reset control switch and closing the test image control switch. In an example, as transmit timing of the test reset signal and test image signal is controlled by the test circuit 300, the CDS circuit 146 may perform a CDS operation between the test reset signal and the test image signal.

According to an embodiment, the ADC 140 may generate the ADC data ADC_OUT based on the CDS data CDS_OUT that have been generated. The ADC data ADC_OUT may correspond to the image data IDATA. For example, the CDS circuit 146 may correspond to the first column of the pixel array 110. In this case, the CDS circuit 146 may generate the CDS data CDS_OUT corresponding to the first column of the pixel array 110 to which the CDS circuit 146 corresponds. The ADC 140 may generate the ADC data ADC_OUT corresponding to the first column based on the generated CDS data CDS_OUT. The generated ADC data ADC_OUT may correspond to the image data IDATA corresponding to the first column.

According to an embodiment, the CDS circuit 146 may sequentially sample and hold a reference signal and an image signal that are provided from the pixel array 110 to each of a plurality of column lines. That is, the CDS circuit 146 may sample and hold the levels of the reference signal and the image signal corresponding to each of the columns of the pixel array 110. In this case, the reference signal may be an electrical signal that is provided to the CDS circuit 146 when the sensing node (e.g., a floating diffusion node) of a pixel is reset. The image signal may be an electrical signal that is provided to the CDS circuit 146 when optical charges generated by a pixel are accumulated in the sensing node.

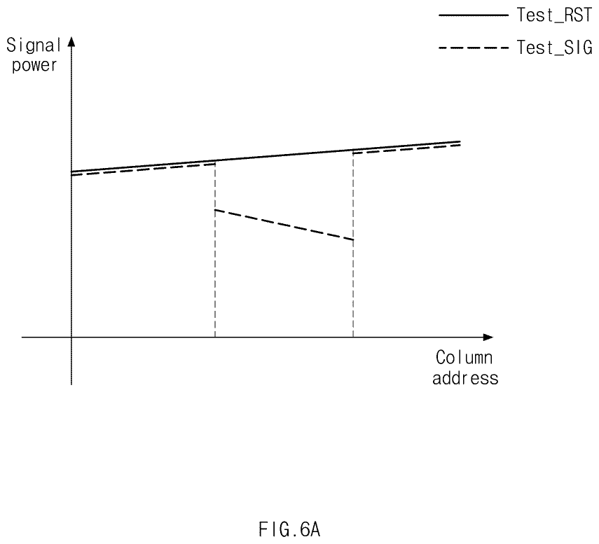

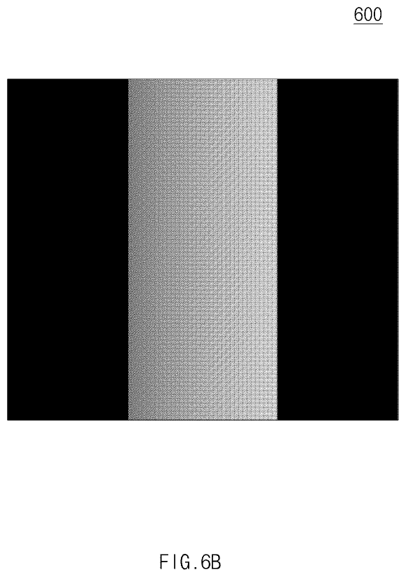

When a value having a small difference between the reference signal and the image signal is input to some CDS circuits of a plurality of CDS circuits and a value having a great difference between the reference signal and the image signal is input to some CDS circuits of a plurality of CDS circuits, band noise (BN) having a band form may occur because signal leakage occurs from a CDS circuit having a great difference between the reference signal and the image signal. The band noise may be noise having a linear band form, which occurs in a readout step of the ADC 140 due to a transistor characteristic, and may include smearing horizontal band noise (SHBN) that occurs in signal amplification and an operation of activating pixels in the same row or column. In an embodiment, when a difference between a reference signal and an image signal that are input to a first CDS circuit corresponding to the first column of the pixel array 110 is great and a difference between a reference signal and an image signal that are input to a second CDS circuit corresponding to a second column of the pixel array 110 is small, band noise may occur in a row region connected to the first CDS circuit, and a noise image having a horizontal stripe may occur in an output image 600 (refer to FIG. 6B).

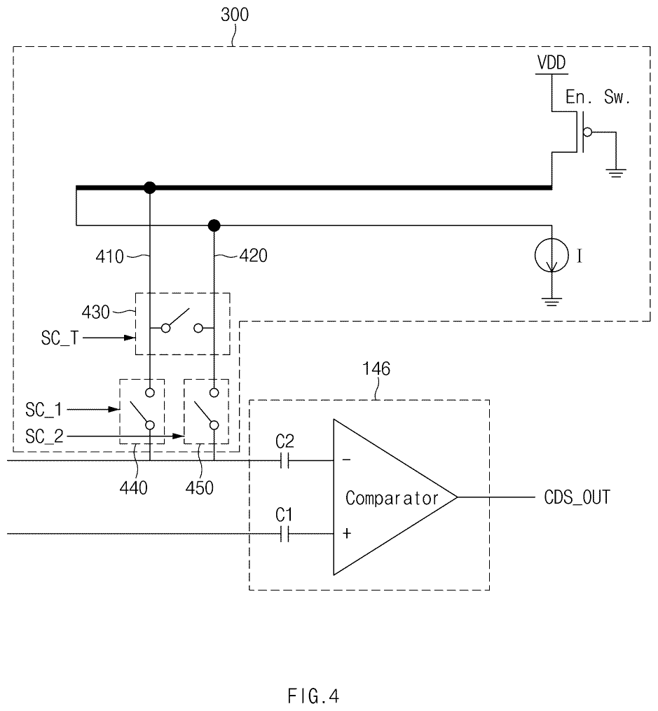

FIG. 4 is a block diagram illustrating a construction according to an embodiment of the test circuit connected to the ADC of FIG. 1, according to an embodiment of the present disclosure.

Referring to FIG. 4, the CDS circuit 146 may be selectively connected to the test circuit 300, and may perform a CDS operation based on a signal that is transmitted by the test circuit 300. That is, in order for the CDS circuit 146 to perform the CDS operation, the CDS circuit 146 may sequentially sample and hold a test reset signal and a test image signal that are generated by the test circuit 300, as in an operation of sequentially sampling and holding a reference signal and an image signal that are provided from the pixel array 110 to each of the plurality of column lines.

The test circuit 300 may generate a test image signal and a test reset signal that are transmitted to the CDS circuit 146. The test image signal may correspond to an image signal that is used in a CDS operation. The test reset signal may correspond to a reference signal that is used in a CDS operation. The CDS circuit 146 may receive the test image signal and the test reset signal from the test circuit 300, and may generate the image data IDATA based on the CDS data CDS_OUT that are generated through the comparator 142 based on the results of the calculation of a difference between the two signals.

The test reset line 410 may be connected to a test reset switch 440 that operates based on a first control signal SC_1, and may connect a relatively thick line that is included in the test circuit 300 and the CDS circuit 146. In an example, when the test reset switch 440 is closed based on the first control signal SC_1, the CDS circuit 146 may receive a test reset signal through a test reset line 410.

A test image line 420 may be connected to a test image switch 450 that operates based on a second control signal SC_2, and may be connected between a relatively thin line connected to the test circuit 300 and the CDS circuit 146. In an example, when the test image switch 450 is closed based on the second control signal SC_2, the CDS circuit 146 may receive a test image signal through the test image line 420. At this time, the voltage value of the test image signal that is transmitted to the CDS circuit 146 through the test image line 420 may correspond to a voltage value that is relatively low compared to the test reset signal.

According to an embodiment, a first voltage value corresponding to the test reset signal and a second voltage value corresponding to the test image signal may be determined based on the resistance value of a circuit to which the test reset signal and the test image signal are transmitted. The first voltage value corresponding to the test reset signal may be greater than the second voltage value corresponding to the test image signal. In an example, the embodiment of FIG. 4 illustrates that the first voltage value and the second voltage value are differently determined due to a difference between the thicknesses of a line (e.g., the relatively thick line included in the test circuit 300) to which the test reset switch 440 to which the test reset signal is transmitted is connected and a line (e.g., the relatively thin line included in the test circuit 300) to which the test image switch 450 to which the test image signal is transmitted is connected, but this is merely an embodiment, and the embodiments of the present disclosure are not limited thereto. For example, the first voltage value and the second voltage value may be determined by a passive element, such as a resistor that is additionally included.

A test control switch 430 may be connected between the test reset line 410 and the test image line 420, and may control a test reset signal and a test image signal that are transmitted to the CDS circuit 146 based on a test control signal SC_T. In an example, when the test control switch 430 is opened, the test reset signal and the test image signal may each have a voltage value corresponding to a voltage value that has been set in the test circuit 300. In an example, the first voltage value corresponding to the test reset signal and the second voltage value corresponding to the test image signal may be adjusted based on the voltage value VDD that has been set in the test circuit 300. In an example, the voltage value VDD that has been set in the test circuit 300 may be turned on or off by at least one transistor included in the test circuit 300. In an example, the at least one transistor included in the test circuit 300 corresponds to an enable switch En. Sw. The voltage value VDD that has been set in the test circuit 300 may be applied to the test circuit 300, or the supply of the voltage value VDD may be blocked by the test circuit 300. For example, in the state in which the test control switch 430 has been opened by the test control signal SC_T, the test reset signal may have a first voltage value, and the test image signal may have a second voltage value that has been subjected to a voltage drop by a predetermined value compared to the first voltage value due to line resistance. The CDS circuit 146 may generate the CDS data CDS_OUT, based on a difference between the first voltage value corresponding to the test reset signal and the second voltage value corresponding to the test image signal.

According to an embodiment, the test reset line 410 and the test image line 420 may correspond to a first column region of the output image. In an example, the test circuit 300 may include a second test reset line and a second test image line. The second test reset line and the second test image line may correspond to a second column region of the output image. In an example, a signal corresponding to the second test reset line may be determined depending on a point at which the second test reset line has been connected to the relatively thick line of the test circuit 300. In an example, a signal corresponding to the second test image line may be determined depending on a point at which the second test image line has been connected to the relatively thin line of the test circuit 300.

In an example, when the test control switch 430 is closed, the test reset signal and the test image signal may have the same voltage value because the test reset line 410 and the test image line 420 have been connected. For example, if the test circuit 300 sets a first voltage value in the test reset signal and the test control switch 430 connected between the test reset line 410 and the test image line 420 has been closed based on the test control signal SC_T, although the test circuit 300 sets a second voltage value in the test image signal, the test image signal that is input to the CDS circuit 146 has the first voltage value. In this case, the CDS circuit 146 may generate the CDS data CDS_OUT based on a difference between the first voltage value corresponding to the test reset signal and the first voltage value corresponding to the test image signal. The CDS data CDS_OUT may correspond to a dark image because there is no difference between the test reset signal and the test image signal that have been input to the CDS circuit 146.

According to an embodiment, the test circuit 300 may set a test reference voltage, and may set the voltage value of the test reset signal and the voltage value of the test image signal by using the test reference voltage and resistance of a line included in the test circuit 300. In an example, the test circuit 300 may set the value of the power supply voltage as VDD. A voltage value corresponding to the test reset signal and a voltage value corresponding to the test image signal may each be a voltage value that has been subjected to a predetermined voltage drop from the power supply voltage VDD. In an example, the test circuit 300 may set a test reference current as a value I by using a current source. At this time, the voltage value of the test reset signal that is transmitted to the CDS circuit 146 through the test reset line 410 may correspond to a voltage value that has been subjected to a voltage drop by a value that is obtained by multiplying the resistance value of a line through which the test reset signal passes by the value I based on the value of the power supply voltage VDD.

According to an embodiment, when the resistance value of the line through which the test reset signal passes is R_RST, the voltage value of the test reset signal that is received by the CDS circuit 146 may correspond to a value “VDD-I*R_RST”. Furthermore, the voltage value of the test image signal that is transmitted to the CDS circuit 146 through the test image line 420 may correspond to a voltage value that has been subjected to a voltage drop by a value that is obtained by multiplying the resistance value of a line through which the test image signal passes by the value I based on the value of the power supply voltage VDD. For example, when the resistance value of the line through which the test reset signal passes is R_SIG, the voltage value of the test reset signal that is received by the CDS circuit 146 may correspond to a value “VDD-I*R_SIG”. In an example, the resistance value R_RST may be smaller than the resistance value R_SIG because the test reset line 410 may be connected to the relatively thick line and the test image line 420 may be connected to the relatively thin line. In an example, the resistance value R_RST may be smaller than the resistance value R_SIG because a path through which the test reset signal passes may be shorter than a path through which the test image signal passes. In an example, the test reset line 410 may be connected to a line corresponding to relatively small resistance, and the test image line 420 may be connected to a line corresponding to relatively great resistance. Accordingly, the resistance value R_RST may be smaller than the resistance value R_SIG.

According to an embodiment, the test circuit 300 may transmit a test reset signal to the CDS circuit 146 by opening the test control switch 430 and the test image switch 450 and closing the test reset switch 440. At this time, a voltage value corresponding to the test reset signal may correspond to the value “VDD-I*R_RST”. In an example, the test circuit 300 may transmit a test image signal to the CDS circuit 146 by opening the test control switch 430 and the test reset switch 440 and closing the test image switch 450. At this time, a voltage value corresponding to the test image signal may correspond to the value “VDD-I*R_SIG”.

According to an embodiment, the test circuit 300 may transmit a test image signal to the CDS circuit 146 by opening the test reset switch 440 and closing the test control switch 430 and the test image switch 450. At this time, a voltage value corresponding to the test image signal may correspond to the value “VDD-I*R_RST” because the test image signal may be transmitted through the relatively thick line without passing through the relatively thin line. In an example, the test circuit 300 may transmit a test reset signal to the CDS circuit 146 by opening the test image switch 450 and closing the test control switch 430 and the test reset switch 440. At this time, a voltage value corresponding to the test reset signal may correspond to the value “VDD-I*R_RST” because the test reset signal may be transmitted through the relatively thick line. In the writing of the voltage value of each signal according to an example, a resistance value that is generated when the resistance value passes through each switch (e.g., 430, 440, or 450) may be considered as a negligible value.

According to an embodiment, the test image signal that is transmitted to the CDS circuit 146 through the test image line 420 may be divided into a first test image signal corresponding to the value “VDD-I*R_SIG” when the test control switch 430 is opened and a second test image signal corresponding to the value “VDD-I*R_RST” when the test control switch 430 is closed according to the opening or closing of the test control switch 430. In an example, the image sensing device 100 may include the CDS circuit 146 corresponding to the test circuit 300 that does not include a test control switch. The CDS circuit 146 corresponding to the test circuit 300 that does not include a test control switch may operate as in the case in which the test control switch 430 is opened.

A CDS control switch (not illustrated) may be connected to the CDS circuit 146 in order to control the input of the reference signal and image signal that are generated by the pixel array 110. An operation of the image sensing device 100 may include an operation of generating test image data based on a signal generated by the test circuit 300, in accordance with an operation of generating the image data IDATA based on a signal generated by the pixel array 110. If the operation of generating the test image data based on the signal generated by the test circuit 300 is performed, the CDS control switch (not illustrated) may block a signal generated by the pixel array 110 from being transmitted to the ADC 140. In an example, if the operation of generating the test image data is performed, the signal generated by the pixel array 110 may be blocked from being transmitted to the ADC 140 based on the on/off state of the CDS control switch (not illustrated) or the opening/closing state of the CDS control switch. The CDS circuit 146 may perform a CDS operation based on the signal generated by the test circuit 300.

According to an embodiment, an image input mode or test mode of the image sensing device 100 may be determined based on the CDS control switch (not illustrated), the test reset switch 440, and the test image switch 450. In an example, when the mode of the image sensing device 100 is the image input mode, the test reset switch 440 and the test image switch 450 may be set to be opened based on the first control signal SC_1 and the second control signal SC_2 because a pixel signal generated by the pixel array 110 needs to be input to the ADC 140. In an example, when the mode of the image sensing device 100 is the test mode, the CDS control switch (not illustrated) may be set to be opened because a test signal (e.g., a test reset signal or a test image signal) generated by the test circuit 400 needs to be input to the ADC 140.

According to an embodiment, the operation of generating the test image data may be performed in a wafer test step of the image sensing device 100. In an example, set voltages of the test reset signal and the test image signal may be applied to the test circuit based on a test pad that is connected to test equipment or a test probe.

According to an embodiment, the test circuit 300 may be connected to a plurality of CDS circuits 146. For example, the test circuit 300 may be connected to the first CDS circuit and the second CDS circuit. In this case, the first CDS circuit may correspond to a first region of the pixel array 110, and the second CDS circuit may correspond to a second region of the pixel array 110. The test image signal generated by the test circuit 300 may be transmitted to the first CDS circuit through a first test image line. The test reset signal generated by the test circuit 300 may be transmitted to the first CDS circuit through a first test reset line. Furthermore, the test image signal generated by the test circuit 300 may be transmitted to the second CDS circuit through a second test image line. The test reset signal generated by the test circuit 300 may be transmitted to the second CDS circuit through a second test reset line.

According to an embodiment, one or more CDS circuits may generate different CDS data CDS_OUT depending on the opening/closing state of the test control switch that is connected between the test reset line that is connected to the CDS circuit and the test image line that is connected to the CDS circuit. For example, when a first test control switch that is connected between the first test reset line and the first test image line is opened, the first CDS circuit may receive a test reset signal corresponding to a first voltage value and a test image signal corresponding to a second voltage value, and may generate first CDS data based on a difference between the first voltage value and the second voltage value. Furthermore, when a second test control switch that is connected between the second test reset line and the second test image line is closed, the second CDS circuit may receive a test reset signal and a test image signal corresponding to the same voltage value as a first voltage value, and may generate second CDS data based on a difference between the same voltage values. At this time, the image data IDATA corresponding to a bright image may be generated based on the first CDS data, and the image data IDATA corresponding to a dark image may be generated based on the second CDS data.

According to an embodiment, the test circuit 300 may further include a switch control circuit (not illustrated) that controls the test control switch 430. In an example, the switch control circuit (not illustrated) may control the opening or closing of the test control switch 430 based on which region of the pixel array 110 the CDS circuit 146 that has been selectively connected to the test control switch 430 corresponds.

According to an embodiment, a user may determine whether a defect having a band noise type of the image sensing device 100 is present by identifying band noise of the output image 600 in a wafer test step. In an embodiment, a bright image has been uniformly distributed to the output image 600 because a test reset signal and a test image signal in the existing wafer test step are uniformly input to each CDS circuit 146 of the image sensing device 100. However, if the test control switch 430 connected to the test reset line and the test image line is used, the test reset signal and the test image signal can be partially input to each CDS circuit 146 of the image sensing device 100 because a difference between the test reset signal and the test image signal can be controlled.

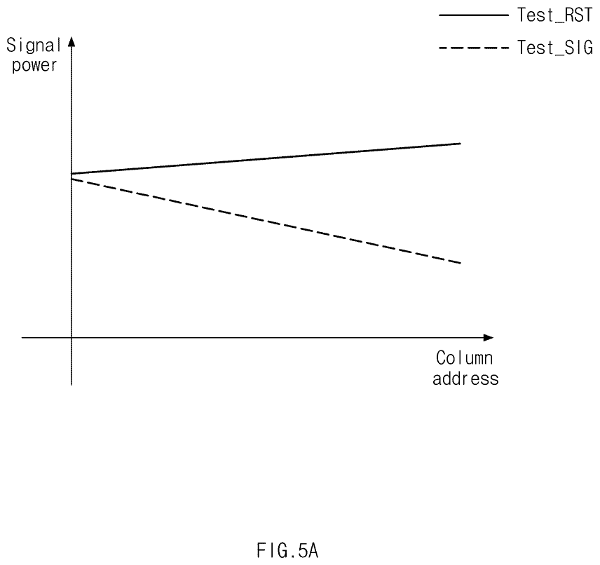

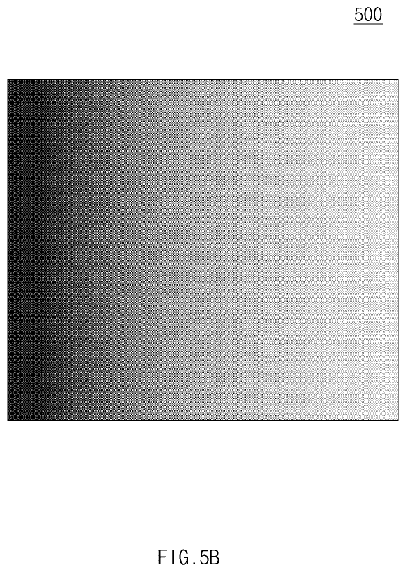

FIG. 5A is a diagram illustrating a difference between power of a test image signal and power of a test reset signal according to an embodiment of the present disclosure.

FIG. 5A may illustrate the power TEST_RST of a test reset signal and the power TEST_SIG of a test image signal, which are received by each CDS circuit 146, based on each of the columns to which the plurality of CDS circuits 146 corresponds. In an example, the test circuit 300 may transmit a test reset signal having relatively small power to the CDS circuit 146 corresponding to a left column of the pixel array 110, and may transmit a test reset signal having relatively great power to the CDS circuit 146 corresponding to a right column of the pixel array 110. Furthermore, the test circuit 300 may transmit a test image signal having relatively great power to the CDS circuit 146 corresponding to the left column of the pixel array 110, and may transmit a test reset signal having relatively small power to the CDS circuit 146 corresponding to the right column of the pixel array 110. In this case, the power TEST_RST of the test reset signal that is generated by the test circuit 300 may be greater than the power TEST_SIG of the test image signal.

According to an embodiment, FIG. 5A may correspond to a wafer test environment in which a test reset signal having gradually greater power is transmitted to each corresponding CDS circuit 146 from the left column of the pixel array 110 to the right column thereof, and may correspond to a wafer test environment in which a test image signal having gradually smaller power is transmitted to each corresponding CDS circuit 146 from the left column of the pixel array 110 to the right column thereof. In an example, when the power TEST_RST of the test reset signal is greater than the power TEST_SIG of the test image signal, a test reset signal having gradually greater power and a test image signal having gradually smaller power may be transmitted to each corresponding CDS circuit 146 corresponding to each column location of the pixel array 110 from the left column of the pixel array 110 to the right column thereof. A difference between the power TEST_RST of the test reset signal and the power TEST_SIG of the test image signal may be gradually increased in each corresponding CDS circuit 146 corresponding to each column location of the pixel array 110 from the left column of the pixel array 110 to the right column thereof.

According to an embodiment, if the test circuit 300 has set the power TEST_RST of the test reset signal that is input to the CDS circuit 146 to be high and has set the power TEST_SIG of the test image signal that is input to the CDS circuit 146 to be low, bright image data corresponding to a difference between the power TEST_RST of the test reset signal and the power TEST_SIG of the test image signal may correspond to the output image. In an example, the test circuit 300 may adjust a difference between the power TEST_RST of the test reset signal and the power TEST_SIG of the test image signal by adjusting a reference voltage value of the test reset signal and a reference voltage value of the test image signal. For example, the test circuit 300 may set a difference between the power TEST_RST of the test reset signal and the power TEST_SIG of the test image signal, which are input to the CDS circuit 146, to be great by setting the reference voltage value of the test reset signal to be high and setting the reference voltage value of the test image signal to be low. In this case, as a difference between the power TEST_RST of the test reset signal and the power TEST_SIG of the test image signal is increased, the output image may correspond to a bright image.

FIG. 5B is an image that is output in accordance with a difference between power of the test image signal and power of the test reset signal in FIG. 5A, according to an embodiment of the present disclosure.

Referring to FIG. 5B, the CDS circuit 146 may generate the CDS data CDS_OUT based on a difference between the power TEST_RST of the test reset signal and the power TEST_SIG of the test image signal. In this case, the ADC 140 may output the CDS data CDS_OUT for each column, which is output by the CDS circuit 146, by converting the CDS data CDS_OUT into a digital signal. In an example, as a difference between the power TEST_RST of the test reset signal and the power TEST_SIG of the test image signal is increased, the CDS data CDS_OUT corresponding to bright image data IDATA may be generated. For example, when the power TEST_RST of the test reset signal and the power TEST_SIG of the test image signal, which are input to the CDS circuit 146 corresponding to the left column of the pixel array 110, are relatively small, dark image data may correspond to the left side of the output image. When the power TEST_RST of the test reset signal and the power TEST_SIG of the test image signal, which are input to the CDS circuit 146 corresponding to the right column of the pixel array 110, are relatively great, bright image data may correspond to the right side of the output image.

According to an embodiment, if the test circuit 300 has set the power TEST_RST of the test reset signal that is input to the CDS circuit 146 to be great and has set the power TEST_SIG of the test image signal that is input to the CDS circuit 146 to be small, bright image data corresponding to a difference between the power TEST_RST of the test reset signal and the power TEST_SIG of the test image signal may correspond to the output image. For example, brighter image data may correspond to the output image as the test circuit 300 sets the power TEST_RST of the test reset signal that is input to the CDS circuit 146 to be greater and sets the power TEST_SIG of the test image signal that is input to the CDS circuit 146 to be smaller.

FIG. 6A is a graph illustrating a difference between power of the test image signal and power of the test reset signal according to an embodiment of the present disclosure. FIG. 6B is an image that is output in accordance with a difference between power of the test image signal and the test reset signal in FIG. 6A, according to an embodiment of the present disclosure.

FIG. 6A may illustrate the power TEST_RST of a test reset signal and the power TEST_SIG of a test image signal, which are received by each of the CDS circuits 146, based on each column to which the plurality of CDS circuits 146 corresponds. In an example, the test circuit 300 may transmit the test reset signal having relatively small power to the CDS circuit 146 corresponding to the left column of the pixel array 110, may transmit the test reset signal having middle power to the CDS circuit 146 corresponding to a middle column (i.e., a center column) of the pixel array 110, and may transmit the test reset signal having relatively great power to the CDS circuit 146 corresponding to the right column of the pixel array 110. At this time, the test control switch connected to the CDS circuit 146 corresponding to the left column of the pixel array 110 may be closed, the test control switch connected to the CDS circuit 146 corresponding to the middle column of the pixel array 110 may be opened, and the test control switch connected to the CDS circuit 146 corresponding to the right column of the pixel array 110 may be closed.

According to an embodiment, if the test circuit 300 has set the power TEST_RST of the test reset signal that is input to the CDS circuit 146 to be great and has set the power TEST_SIG of the test image signal that is input to the CDS circuit 146 to be small, bright image data corresponding to a difference between the power TEST_RST of the test reset signal and the power TEST_SIG of the test image signal may correspond to the output image. In an example, a difference between the power TEST_RST of the test reset signal and the power TEST_SIG of the test image signal may be adjusted by the opening or closing of the test control switch 430.

According to an embodiment, after the test circuit 300 sets a reference voltage value of the test reset signal to be great and sets a reference voltage value of the test image signal to be small, the test control switch that is connected to the CDS circuit 146 corresponding to the left column of the pixel array 110 may be closed, the test control switch that is connected to the CDS circuit 146 corresponding to the middle column of the pixel array 110 may be opened, and the test control switch that is connected to the CDS circuit 146 corresponding to the right column of the pixel array 110 may be closed. At this time, a difference between the power TEST_RST of the test reset signal and the power TEST_SIG of the test image signal may be small in the CDS circuit 146 corresponding to the left column of the pixel array 110. A difference between the power TEST_RST of the test reset signal and the power TEST_SIG of the test image signal may be great in the CDS circuit 146 corresponding to the middle column of the pixel array 110. A difference between the power TEST_RST of the test reset signal and the power TEST_SIG of the test image signal may be small in the CDS circuit 146 corresponding to the right column of the pixel array 110.

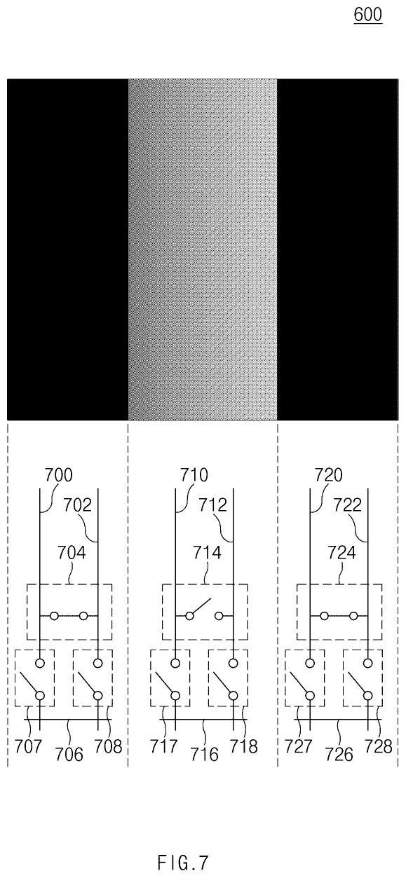

FIG. 7 is a diagram for describing an operation of the test circuit of FIG. 4 corresponding to the image of FIG. 6B, according to an embodiment of the present disclosure.

Referring to FIG. 7, the CDS circuit 146 may generate the CDS data CDS_OUT based on a difference between the test reset signal and the test image signal. In this case, the ADC 140 may output the CDS data CDS_OUT for each column, which are output by the CDS circuit 146, by converting the CDS data CDS_OUT into a digital signal. In an example, as a difference between the power TEST_RST of the test reset signal and the power TEST_SIG of the test image signal is increased, the CDS data CDS_OUT corresponding to bright image data IDATA may be generated. For example, when the power TEST_RST of the test reset signal and the power TEST_SIG of the test image signal, which are input to the CDS circuit corresponding to the left column of the pixel array 110, are relatively small, dark image data may correspond to a left side of the output image. When the power TEST_RST of the test reset signal and the power TEST_SIG of the test image signal, which are input to the CDS circuit corresponding to the middle column of the pixel array 110, are relatively great, bright image data may correspond to the middle (center) of the output image. When the power TEST_RST of the test reset signal and the power TEST_SIG of the test image signal, which are input to the CDS circuit corresponding to the right column of the pixel array 110, are relatively small, dark image data may correspond to a right side of the output image.

According to an embodiment, if the test circuit 300 has set the power TEST_RST of the test reset signal that is input to the CDS circuit 146 to be great and has set the power TEST_SIG of the test image signal that is input to the CDS circuit 146 to be small, bright image data corresponding to a difference between the power TEST_RST of the test reset signal and the power TEST_SIG of the test image signal may correspond to the output image. For example, when a difference between the power TEST_RST of the test reset signal and the power TEST_SIG of the test image signal, which have been input to the CDS circuit corresponding to the left column of the pixel array 110, is small, the dark image data may correspond to a left side of the output image. When a difference between the power TEST_RST of the test reset signal and the power TEST_SIG of the test image signal, which have been input to the CDS circuit corresponding to the middle column of the pixel array 110, is small, dark image data may correspond to the middle of the output image. When a difference between the power TEST_RST of the test reset signal and the power TEST_SIG of the test image signal, which have been input to the CDS circuit corresponding to the right column of the pixel array 110, is small, dark image data may correspond to a right side of the output image.

According to an embodiment, upon operation of the test circuit 300, the image data of the output image 600 in a row direction may be adjusted by controlling a row circuit that is connected to the CDS circuit 146. In an example, upon operation of the test circuit 300, the row circuit corresponding to the CDS circuit 146 may include a row control switch. If the row circuit corresponding to the CDS circuit 146 corresponds to a center part of the pixel array, the row control switch may be set to be opened. If the row circuit corresponding to the CDS circuit 146 corresponds to an edge part of the pixel array, the row control switch may be set to be closed.

According to an embodiment, the test control switch that is connected to the CDS circuit corresponding to the middle column of the pixel array 110 may be closed. The test control switches that are connected to CDS circuits corresponding to left and right columns of the pixel array 110 may be opened. Furthermore, if a row switch corresponding to the CDS circuit corresponds to a center part (e.g., a middle row) of the pixel array, the row control switch may be set to be opened. If a row switch corresponding to the CDS circuit corresponds to an edge part (e.g., an upper side row and lower side row) of the pixel array, the row control switch may be set to be closed. In this case, bright image data may correspond to only some regions of the center of the output image, and dark image data may correspond to an edge region of the output image.

According to an embodiment, the CDS circuit may generate the CDS data CDS_OUT based on a difference between the test reset signal and the test image signal. In this case, the ADC may output the CDS data CDS_OUT for each row, which are output by the CDS circuit, by converting the CDS data CDS_OUT into a digital signal. In an example, as a difference between the power TEST_RST of the test reset signal and the power TEST_SIG of the test image signal is increased, the CDS data CDS_OUT corresponding to bright image data IDATA may be generated. For example, when the power TEST_RST of the test reset signal and the power TEST_SIG of the test image signal that are input to the CDS circuit corresponding to an upper row of the pixel array 110 are relatively small, dark image data may correspond to the upper side of the output image. When the power TEST_RST of the test reset signal and the power TEST_SIG of the test image signal that are input to the CDS circuit corresponding to a middle row of the pixel array 110 are relatively great, bright image data may correspond to the middle of the output image. When the power TEST_RST of the test reset signal and the power TEST_SIG of the test image signal that are input to the CDS circuit corresponding to a lower column of the pixel array 110 are relatively small, dark image data may correspond to the lower side of the output image. In an example, unlike a column CDS circuit, the CDS circuit that outputs the CDS data CDS_OUT for each row of the pixel array by converting the CDS data CDS_OUT into a digital signal may correspond to a row CDS circuit.

According to an embodiment, if the test circuit 300 has set the power TEST_RST of the test reset signal that is input to the CDS circuit 146 to be great and has set the power TEST_SIG of the test image signal that is input to the CDS circuit 146 to be small, bright image data corresponding to a difference between the power TEST_RST of the test reset signal and the power TEST_SIG of the test image signal may correspond to the output image. For example, when a difference between the power TEST_RST of the test reset signal and the power TEST_SIG of the test image signal that have been input to the CDS circuit corresponding to an upper row of the pixel array 110 is small, dark image data may correspond to the upper side of the output image. When a difference between the power TEST_RST of the test reset signal and the power TEST_SIG of the test image signal that have been input to the CDS circuit corresponding to a middle row (i.e., a center row) of the pixel array 110 is small, dark image data may correspond to the middle of the output image. When a difference between the power TEST_RST of the test reset signal and the power TEST_SIG of the test image signal that have been input to the CDS circuit corresponding to a lower row of the pixel array 110 is small, dark image data may correspond to the lower side of the output image.

According to an embodiment, in a wafer test step, the test circuit 300 may create an environment in which band noise occurs by controlling a difference between a test reset signal and a test image signal that are input to each of a plurality of CDS circuits by using the test control switch 430. In an example, the test circuit 300 may make dark image data correspond to the left side of the output image 600 by making relatively small the power TEST_RST of the test reset signal and the power TEST_SIG of the test image signal that are input to the CDS circuit corresponding to the left column of the pixel array 110 by using the test control switch 430. The test circuit 300 may make bright image data correspond to the middle of the output image 600 by making relatively great the power TEST_RST of the test reset signal and the power TEST_SIG of the test image signal that are input to the CDS circuit corresponding to the middle column of the pixel array 110. The test circuit 300 may make dark image data correspond to the right side of the output image by making relatively small the power TEST_RST of the test reset signal and the power TEST_SIG of the test image signal that are input to the CDS circuit corresponding to the right column of the pixel array 110.

According to an embodiment, band noise has been determined based on the output image that is output based on a pixel signal not a signal that is input from the test circuit because the band noise may be detected in an environment in which light is incident on some regions of the pixel array. If the test control switch 430 that is connected to the test reset line and the test image line is used, band noise may be determined based on a signal that is input from the test circuit because a different difference between the test reset signal and the test image signal may be input to each of the plurality of CDS circuits 146. For example, a user may determine whether band noise of the output image 600 is present in a way to input a signal in which a difference between the test reset signal and the test image signal is relatively small to the first CDS circuit by closing the test control switch connected to the first CDS circuit and input a signal in which a difference between the test reset signal and the test image signal is relatively great to the second CDS circuit by closing the test control switch connected to the second CDS circuit, in the wafer test step. In this case, the user may determine whether the image sensing device 100 includes a defect based on whether the determined band noise of the output image 600 is present.

According to an embodiment, the test circuit 300 may further include a switch control circuit (not illustrated) that controls the test control switch 430. The switch control circuit may close the test control switch when the test control switch is a CDS circuit corresponding to the left region of the pixel array, may open the test control switch when the test control switch is a CDS circuit corresponding to a middle (center) region of the pixel array, and may close the test control switch when the test control switch is a CDS circuit corresponding to a right region of the pixel array.

According to an embodiment, after the test circuit 300 sets a reference voltage value of the test reset signal to be high and sets a reference voltage value of the test image signal to be low, the test circuit 300 may transmit a test reset signal and a test image signal to a CDS circuit (e.g., 706, 716, or 726) by adjusting a test reset switch (e.g., 707, 717, or 727) and a test image switch (e.g., 708, 718, or 728) that are connected to a test reset line (e.g., 700, 710, or 720) and a test image line (e.g., 702, 712, or 722). In an example, a test control switch 704 that is connected to the CDS circuit 706 corresponding to the left column of the pixel array 110 may be closed. A test control switch 714 that is connected to the CDS circuit 716 corresponding to the middle column of the pixel array 110 may be opened. A test control switch 724 that is connected to the CDS circuit 726 corresponding to the right column of the pixel array 110 may be closed. In this case, dark image data may correspond to the left of the output image 600, bright image data may correspond to the middle of the output image 600, and dark image data may correspond to the right of the output image 600.

According to an embodiment, the test circuit 300 may reduce a difference between the test reset signal and the test image signal that are input to a first CDS circuit 706 by closing the test control switch 704 that is connected to the first CDS circuit 706 corresponding to the left column of the pixel array 110. Furthermore, the test circuit 300 may adjust timing of the test reset signal and the test image signal that are transmitted to the first CDS circuit 706 by adjusting a first test reset switch 707 and a first test image switch 708. For example, the test circuit 300 may transmit a test reset signal to the first CDS circuit 706 through a first test reset line 700, and may transmit a test image signal to the first CDS circuit 706 through a first test image line 702. In this case, a difference between power of the test reset signal and power of the test image signal that are input to the first CDS circuit 706 may be reduced by closing the test control switch 704 corresponding to the first CDS circuit 706. Dark image data may correspond to the left region of the output image 600 corresponding to the first CDS circuit 706 based on a reduction in the difference between the power of the test reset signal and the power of the test image signal that are input to the first CDS circuit 706.

According to an embodiment, the test circuit 300 may open the test control switch 714 that is connected to a second CDS circuit 716 corresponding to the middle column of the pixel array 110, may transmit a test reset signal to the second CDS circuit 716 through a second test reset line 710, and may transmit a test image signal to the second CDS circuit 716 through a second test image line 712. Furthermore, the test circuit 300 may adjust timing of the test reset signal and the test image signal that are transmitted to the second CDS circuit 716 by adjusting a second test reset switch 717 and a second test image switch 718. At this time, a difference between power of the test reset signal and power of the test image signal that are input to the second CDS circuit 716 by opening the test control switch 714 corresponding to the second CDS circuit 716 may correspond to a difference between power of the test reset signal and power of the test image signal, which have been preset in the test circuit 300. Relatively bright image data may correspond to a middle region of the output image 600 corresponding to the second CDS circuit 716, based on the difference between the power of the test reset signal and the power of the test image signal that are input to the second CDS circuit 716.

According to an embodiment, the test circuit 300 may reduce a difference between a test reset signal and a test image signal that are input to a third CDS circuit 726 by closing a test control switch 724 that is connected to the third CDS circuit 726 corresponding to the right column of the pixel array 110. Furthermore, the test circuit 300 may adjust timing of the test reset signal and the test image signal that are transmitted to the third CDS circuit 726 by adjusting a third test reset switch 727 and a third test image switch 728. For example, the test circuit 300 may transmit the test reset signal to the third CDS circuit 726 through a third test reset line 720, and may transmit the test image signal to the third CDS circuit 726 through a third test image line 722. In this case, a difference between power of the test reset signal and power of the test image signal that are input to the third CDS circuit 726 may be reduced by closing the test control switch 724 corresponding to the third CDS circuit 726. Dark image data may correspond to a right region of the output image 600 corresponding to the third CDS circuit 726, based on a reduction in the difference between the power of the test reset signal and the power of the test image signal that are input to the third CDS circuit 726.

According to an embodiment, a difference between the test reset signal and the test image signal that are input to each of the first CDS circuit 706 and the third CDS circuit 726 may be relatively small regardless of a difference between a test reset signal and a test image signal that have been set by the test circuit 300, by closing a test control switch (e.g., 704 or 724) that is connected to each of the first CDS circuit 706 and the third CDS circuit 726. For example, referring to FIG. 7 along with FIG. 6B, when test control switches (e.g., 704 and 724) connected to the first CDS circuit 706 and the third CDS circuit 726, respectively, are closed, the test image signals that are input to the first CDS circuit 706 and the third CDS circuit 726 may correspond to left and right graphs in FIG. 6B, respectively. In an example, the test image signals that are input to the first CDS circuit 706 and the third CDS circuit 726 may have the same size as the test reset signals that are input to the first CDS circuit 706 and the third CDS circuit 726.

According to an embodiment, a difference between the test reset signal and the test image signal that are input to the second CDS circuit 716 may have a value corresponding to a difference between a test reset signal and a test image signal, which have been set by the test circuit 300, by opening the test control switch 714 that is connected to the second CDS circuit 716. For example, referring to FIG. 7 along with FIG. 6B, when the test control switch 714 connected to the second CDS circuit 716 is opened, the test image signal that is input to the second CDS circuit 716 may correspond to a middle part of the graph in FIG. 6B. In an example, a difference between the test reset signal and the test image signal that are input to the second CDS circuit 716 may be the same as a difference between a test reset signal and a test image signal that have been preset by the test circuit 300.

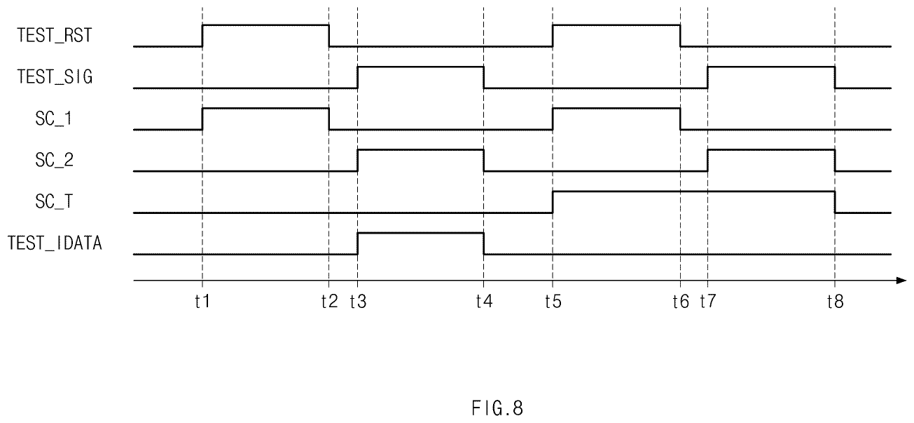

FIG. 8 is a timing diagram of the test circuit, according to an embodiment of the present disclosure.

Referring to FIG. 8, when the first control signal SC_1 is a logic high level at t1 to t2, the test reset signal TEST_RST may have a logic high level at t1 to t2. When the first control signal SC_1 is a logic low level at t2 to t5, the test reset signal TEST_RST may have a logic low level at t2 to t5. In an example, when the second control signal SC_2 is a logic high level at t7 to t8, the test image signal TEST_SIG may have a logic high level at t7 to t8. When the second control signal SC_2 is a logic low level at t4 to t7, the test image signal TEST_SIG may have a logic low level at t4 to t7.

According to an embodiment, when the test control switch is a logic low level at t1 to t4, the test reset signal TEST_RST and the test image signal TEST_SIG may have a difference between voltage values. Accordingly, a test image TEST_IDATA may be output as a bright image. For example, when the test control switch is a logic low level at t1 to t4, the test control switch may be opened, the test reset signal TEST_RST may have a relatively high voltage value, and the test image signal TEST_SIG may have a relatively low voltage value. Accordingly, the test image TEST_IDATA may be output as a bright image corresponding to a difference between the voltage values of the test reset signal TEST_RST and the test image signal TEST_SIG.

According to an embodiment, when the test control switch is a logic high level at t5 to t8, the test reset signal TEST_RST and the test image signal TEST_SIG may have the same voltage value. Accordingly, the test image TEST_IDATA may be output as a dark image. For example, when the test control switch is a logic high level at t5 to t8, the test control switch may be closed, and the test reset signal TEST_RST and the test image signal TEST_SIG may have the same voltage value or a difference between voltage values which is relatively small. Accordingly, the test image TEST_IDATA may be output as a relatively dark image. In an example, brightness of the test image TEST_IDATA may be determined based on a difference between a voltage value of the test reset signal TEST_RST and a voltage value of the test image signal TEST_SIG, after the voltage value of the test reset signal TEST_RST is calculated and the voltage value of the test image signal TEST_SIG is then calculated.

Although a number of illustrative embodiments have been described, it should be understood that modifications and enhancements to the disclosed embodiments and other embodiments can be devised based on what is described and/or illustrated in the present disclosure. Furthermore, the embodiments may be combined to form additional embodiments.

What is claimed is:

1. An image sensing device comprising:
a test control switch configured to selectively connect a test reset line for transmitting a test reset signal and a test image line for transmitting a first test image signal; and
a first correlated double sampling (CDS) circuit configured to receive the test reset signal through the test reset line and receive the first test image signal through the test image line,
wherein the first CDS circuit is configured to receive a second test image signal through the test image line when the test control switch is closed.

2. The image sensing device of claim 1, wherein the first CDS circuit includes a column CDS circuit corresponding to at least one column of a pixel array.

3. The image sensing device of claim 1, wherein the first CDS circuit corresponds to at least some region of the pixel array.

4. The image sensing device of claim 3, wherein:
when the first CDS circuit corresponds to a first region of the pixel array, the test control switch is closed; and
when the first CDS circuit corresponds to a second region of the pixel array, the test control switch is opened.

5. The image sensing device of claim 4, wherein:
the first region corresponds to a center part of the pixel array; and
the second region corresponds to an edge part of the pixel array.

6. The image sensing device of claim 3, wherein:
when a row circuit corresponding to the first CDS circuit corresponds to a center part of the pixel array, the test control switch is closed; and
when the row circuit corresponding to the first CDS circuit corresponds to an edge part of the pixel array, the test control switch is opened.

7. The image sensing device of claim 6, wherein the row circuit comprises at least one of a row control switch and a row CDS circuit.

8. The image sensing device of claim 1, further comprising a test circuit configured to generate the test reset signal and the first test image signal.

9. The image sensing device of claim 8, further comprising a second CDS circuit configured to receive the test reset signal and the first test image signal.

10. The image sensing device of claim 1, further comprising a switch control circuit configured to identify a CDS circuit corresponding to the test control switch and control an opening or closing of the test control switch depending on a region of the pixel array corresponding to the identified CDS circuit.

11. The image sensing device of claim 1, further comprising a CDS control switch connected to the CDS circuit and configured to block a pixel signal that is generated from a pixel array transmitted to the CDS circuit.

12. An image sensing device comprising:
a test control switch configured to selectively connect a test reset line for transmitting a test reset signal generated from a test circuit and a test image line for transmitting a test image signal generated from the test circuit; and
a correlated double sampling (CDS) circuit configured to receive the test image signal through the test image line and receive the test reset signal through the test reset line,
wherein the test control switch is configured to control a difference between the test image signal and the test reset signal that are input to the CDS circuit.

13. A method of controlling an image sensing device, the method comprising:
transmitting a test image signal and a test reset signal through a first test image line and a first test reset line, respectively, to a first correlated double sampling (CDS) circuit included in the image sensing device;
transmitting a test image signal and a test reset signal through a second test image line and a second test reset line, respectively, to a second CDS circuit included in the image sensing device; and
controlling a difference between the test image signal and the test reset signal that are input to the first CDS circuit by selectively connecting the first test image line and the first test reset line.

14. The method of claim 13, wherein:
the first CDS circuit corresponds to a first region of a pixel array; and
the second CDS circuit corresponds to a second region of the pixel array.

15. The method of claim 14, wherein:
the first region includes a first column of the pixel array; and
the second region includes a second column of the pixel array.

16. The method of claim 13, further comprising:
generating, by the first CDS circuit, first CDS data based on a difference between the test image signal and the test reset signal; and
generating, by the second CDS circuit, second CDS data based on a difference between the test image signal and the test reset signal.

17. The method of claim 16, further comprising:
generating image data based on the first CDS data and the second CDS data; and
detecting band noise (BN) of the image data.

18. The method of claim 13, wherein controlling the difference between the test image signal and the test reset signal comprises changing a voltage level of the test image signal that is input to the first CDS circuit into a voltage level identical with a voltage level of the test reset signal by connecting the first test image line and the first test reset line.

19. The method of claim 13, wherein the test reset signal and the test image signal are generated from a test circuit.

20. The method of claim 13, further comprising selectively connecting the first test image line and the first test reset line depending on a region of a pixel array to which the first CDS circuit corresponds.
